(19) United States
(12) Patent Application Publication
(10) Pub. No.: US 2023/0295947 A1
(43) Pub. Date: Sep. 21, 2023

(54) MANAGEMENT METHOD OF SAFETY SMART SHELTER FOR DISASTER EVACUATION

(71) Applicant: DWELLING CO.,LTD, Seoul (KR)

(72) Inventor: Jeong Hwan JEON, Seoul (KR)

(73) Assignee: DWELLING CO.,LTD, Seoul (KR)

(21) Appl. No.: 18/019,827

(22) PCT Filed: Aug. 4, 2021
(86) PCT No.: PCT/KR2021/010198

§ 371 Date: Feb. 27, 2023

(30) Foreign Application Priority Data
Aug. 6, 2020 (KR) 10-2020-0098519

(51) Int. Cl. E04H 9/16; E04H 9/14

(52) U.S. Cl. CPC E04H 9/16; E04H 9/14

(57) ABSTRACT

A method for operating a disaster safe smart shelter includes: a step (a) for transmitting, by a transmitter installed in an arbitrary bus, operation data including a plurality of pieces of bus operation-related information; a step (b) for receiving, by the receiver, operation data transmitted from transmitters installed in one or more buses, calculating an entry order of buses to arrive at the disaster safe smart shelter, on the basis of the operation data, and assigning the entry order to each of the n sectors, a step (c) for identifying, by a sensor module installed in each of the n sectors, whether a bus assigned in the step (b) enters, and a step (d) for opening and shutting, by the door control unit, the opening and shutting door of a sector where the entering of the bus is identified in the step (c).

### TECHNICAL FIELD

The present invention relates to a method for operating a disaster safe smart shelter, and more particularly, to a method for operating a disaster safe smart shelter for effectively operating a disaster safe smart shelter installed outdoors to enable users to evacuate from various social and natural disasters and to additionally provide various complex functions.

### BACKGROUND ART

In recent years, as interest in large and small social and natural disasters such as fine dust, heat waves, and cold waves have increased, it is urgent to prepare countermeasures for citizens' health and welfare. Therefore, various countermeasures are being sought for such social and natural disasters, but none of them have been effective so far.

In addition, in general, stops of public transportation for ground transportation such as buses, taxis, and ground railways may be often installed outdoors, and passengers using public transportation are directly exposed to such outdoor environments.

Therefore, passengers cannot help but suffer damage from various social and natural disasters as described above, and in the case of seasons such as summer or winter, passengers on waiting have no choice but to endure heat or cold.

In addition, since people will wait with an umbrella supported in case of rain or snowfall, a waiting line is longer than usual, especially in the case of a bus stop with many passengers, and clothes, shoes, etc., are wet from moisture while standing by to cause discomfort.

Therefore, it is necessary to utilize structures that may provide various functions such as a waiting station for public transportation while allowing citizens to evacuate from various social and natural disasters to protect their health.

In particular, when such a structure is used as a waiting station for public transportation such as a bus, it is necessary to provide various types of information so that many passengers may improve the convenience of using the bus in line with the latest trend. However, since waiting stations in operation so far provide only simple arrival information for public transportation, there is a great need for improvement.

In addition, since multiple buses frequently stop at the same time at a bus stop, at a bus stop with high congestion, a lot of effort is required to move passengers to a stop position of a bus they need to board. Therefore, accidents may occur due to physical contact with other passengers while moving.

Therefore, a method for solving these problems is required.

### DISCLOSURE

### Technical Problem

The present invention is devised to solve the problems of the prior art described above, and an object of the present invention is to effectively operate a disaster safe smart shelter, which is installed outdoors to enable users to evacuate from various social and natural disasters and additionally provides various complex functions, through an operating algorithm based on Internet of Things (IoT).

Problems of the present invention are not limited to the above-described problems. That is, other problems that are not described may be obviously understood by those skilled in the art from the following specification.

### Technical Solution

To accomplish the above object of the present invention, according to a first embodiment of the present invention, there is provided a method for operating a disaster safe smart shelter including n sectors installed at a bus station, having formed therein a waiting space where a user waits, n sectors where a bus stops, and an opening and shutting door installed at each of the n sectors, and a door control unit for controlling the opening and shutting door, the method for operating a disaster safe smart shelter including: a step (a) for transmitting, by a transmitter installed in an arbitrary bus, operation data including a plurality of pieces of bus operation-related information to a receiver installed in the disaster safe smart shelter installed at the bus station to arrive later; a step (b) for receiving, by the receiver, operation data transmitted from transmitters installed in one or more buses, calculating an entry order of buses to arrive at the disaster safe smart shelter, on the basis of the operation data, and assigning the entry order to each of the n sectors; a step (c) for identifying, by a sensor module installed in each of the n sectors, whether a bus assigned in the step (b) enters; and a step (d) for opening and shutting, by the door control unit, the opening and shutting door of a sector where the entering of the bus is identified in the step (c).

A repeater may be installed between bus stops adjacent to each other, and between the step (a) and the step (b), a step (ex-1) for receiving, by the repeater, the operation data transmitted from the transmitter installed in one or more buses and then transmitting the operation data to the receiver may be further performed.

The opening and shutting door may includes a first opening and shutting door corresponding to a front door of the bus and a second opening and shutting door corresponding to a rear door of the bus, and the sensor module may include an entry identification sensor that determines whether the bus enters, a front door identification sensor that identifies whether the front door of the bus is opened and shut, and a rear door identification sensor that identifies whether the rear door of the bus is opened and shut.

In this case, the step (d) may include a step (d-1) for opening, by the door control unit, the first opening/closing door of the corresponding sector when the front door identification sensor detects that the front door of the bus is opened, a step (d-2) for opening, by the door control unit, the second opening/closing door of the corresponding sector when the rear door identification sensor detects that the rear door of the bus is opened, a step (d-3) for shutting, by the door control unit, the first opening/closing door of the corresponding sector when the front door identification sensor detects that the front door of the bus is shut, and a step (d-4) for shutting, by the door control unit, the second opening/closing door of the corresponding sector when the rear door identification sensor detects that the rear door of the bus is shut.

In addition, the disaster safe smart shelter may further include a guidance module that is installed in each of the n sectors, the sensor module may include an entry identification sensor that determines whether the bus enters, and the step (c) may includes a step (c-1) for determining, by the entry identification sensor, whether the bus assigned to the corresponding sector is adjacent to a preset distance, a step (c-2) for controlling, by the receiver, the guidance module to display a stop induction signal when it is determined in the step (c-1) that the bus is adjacent to a preset distance, and a step (c-3) for identifying, by the entry identification sensor, whether the assigned bus enters.

The disaster safe smart shelter may further include a screen module that displays the operation data, and a step (ex-2) for displaying the entry order of the buses to arrive at the disaster safe smart shelter and information on the sector assigned for the bus to stop may be further performed between the step (b) and the step (c).

To accomplish the above object of the present invention, according to a second embodiment of the present invention, there is provided a method for operating a disaster safe smart shelter including an air purifying module that is installed at a bus station, has formed therein a waiting space where a user waits, and purifies air flowing through an air flow path connecting the waiting space and an outside, a cooling and heating module that controls a temperature of the air flowing through the air flow path, and an air conditioning control unit that controls the air purifying module and the cooling and heating module, the method for operating a disaster safe smart shelter including: a step (A) for setting an air purifying condition for operating the air purifying module through the air conditioning control unit; a step (B) for setting a cooling and heating condition for operating the cooling and heating module through the air conditioning control unit; a step (C) for controlling, by the air conditioning control unit, the air purifying module to operate when the air purifying condition is satisfied; and a step (D) for controlling, by the air conditioning control unit, the cooling and heating module to operate when the cooling and heating condition is satisfied.

In this case, the disaster safe smart shelter may further include a sensor module including an air quality detection sensor that detects a concentration of fine dust outside and an air quality detection sensor that detects a concentration of fine dust inside a waiting space S, in which in the step (C), when it is detected by the air quality detection sensor that the concentration of the fine dust is equal to or greater than a preset concentration, it is determined that the air purifying condition is satisfied, and thus, the air conditioning control unit may control the air purifying module to operate.

The disaster safe smart shelter may further include a sensor module including a temperature detection sensor that detects a temperature of the waiting space, and in the step (D), when it is detected by the temperature detection sensor that the temperature of the waiting space is out of a preset appropriate temperature range, it is determined that the cooling and heating condition is satisfied, and thus, the air conditioning control unit may control the cooling and heating module to operate.

Meanwhile, in the step (C), when a preset air purifying set time arrives, it is determined that the air purifying condition is satisfied, and thus, the air purifying control unit may control the air purifying module to operate.

In addition, in the step (D), when a preset cooling and heating time arrives, it is determined that the cooling and heating condition is satisfied, and thus, the air conditioning control unit may control the cooling and heating module to operate.

### Advantageous Effects

A method for operating a disaster safe smart shelter of the present invention for solving the above problems can provide a pleasant internal environment so that users can evacuate from various social and natural disasters, and additionally provide various complex functions.

In particular, when the disaster safe smart shelter is installed at a bus stop and used as a waiting station, it is possible to provide various types of information to passengers through an operating algorithm based on the Internet of Things (IoT), and provide a safe getting on and off environment by controlling an opening and shutting doors of the disaster safe smart shelter by interlocking with a bus entry and stop process.

The effects of the present invention are not limited to the above-described effects. That is, other effects that are not described may be obviously understood by those skilled in the art from the claims.

### DESCRIPTION OF DRAWINGS

FIG. 1 is a diagram showing an appearance of a disaster safe smart shelter to which a method for operating a disaster safe smart shelter according to a first embodiment of the present invention is applied.

FIG. 2 is a diagram schematically showing a connection relationship between each component interlocking with to a bus operation in the method of operating a disaster safe smart shelter according to the first embodiment of the present invention.

FIG. 3 is a diagram showing the entire process of the method for operating a disaster safe smart shelter according to a first embodiment of the present invention.

FIG. 4 is a diagram showing a detailed process of step (C) in the method for operating a disaster safe smart shelter according to the first embodiment of the present invention.

FIG. 5 is a diagram showing a detailed process of step (D) in the method for operating a disaster safe smart shelter according to the first embodiment of the present invention.

FIG. 6 is a diagram schematically illustrating a connection relationship between components interlocking with air conditioning control in the method for operating a disaster safe smart shelter according to a second embodiment of the present invention.

FIG. 7 is a diagram showing the entire process of the method for operating a disaster safe smart shelter according to the second embodiment of the present invention.

### BEST MODE

Hereinafter, a preferred embodiment of the present invention in which the object of the present invention may be realized in detail will be described with reference to the accompanying drawings. In describing the present embodiment, the same name and the same reference numeral are used for the same configuration, and additional description thereof will be omitted.

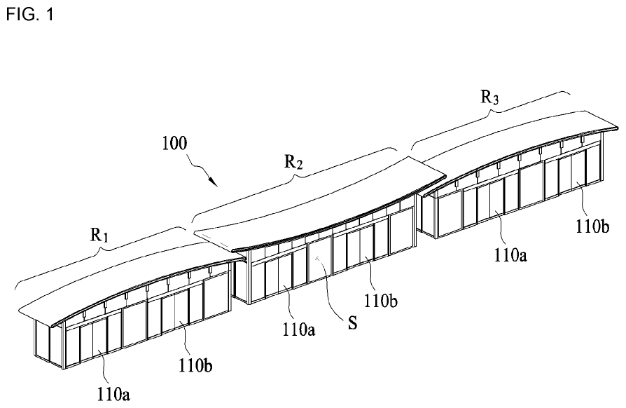

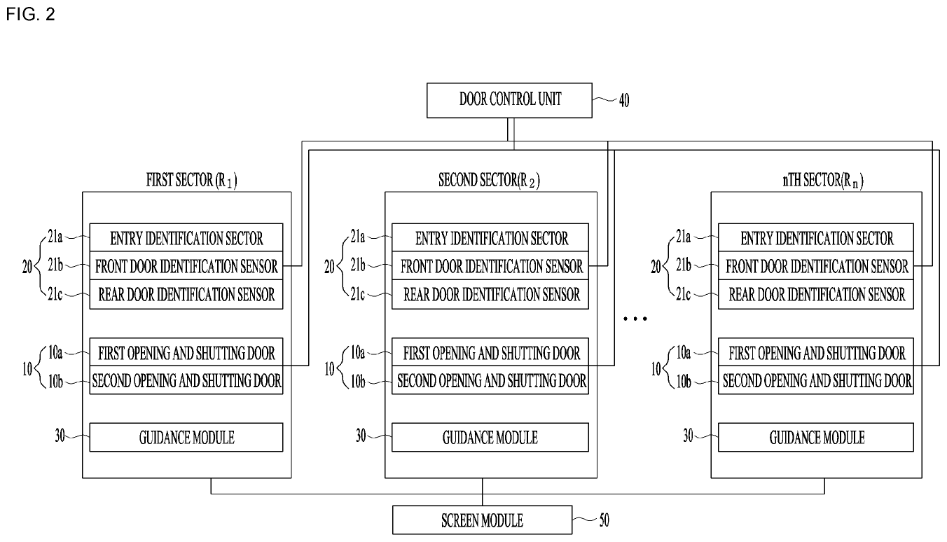

FIG. 1 is a diagram showing an appearance of a disaster safe smart shelter 100 to which a method for operating a disaster safe smart shelter according to a first embodiment of the present invention is applied, and FIG. 2 is a diagram schematically showing a connection relationship between each component interlocking with to a bus operation in the method of operating a disaster safe smart shelter 100 according to the first embodiment of the present invention.

Referring to FIGS. 1 and 2, the disaster safe smart shelter 100 according to the present invention may be installed outdoors. In particular, it is exemplified that the disaster safe smart shelter 100 shown in the present embodiment to be described below is installed at a bus stop and performs a function of a shelter for public transportation along with a function of disaster avoidance, but this is limited only to the present embodiment, and may be applied not only to public transportation stops, but also to various waiting stations and structures installed for special purposes.

In addition, the present invention has the advantage that users may conveniently and comfortably wait through various additional functions operating based on Internet of Things (IoT) as well as a disaster avoidance function.

In addition, the disaster safe smart shelter 100 according to the present embodiment has a waiting space S where a user enters and wait, and opening and shutting doors 10a and 10b that are formed on side walls and enter and exit the waiting space S may be formed.

In addition, the disaster safe smart shelter 100 includes n sectors R1, R2, and R3 where a bus stops, and these n sectors R1, R2, and R3 may be provided with the opening and shutting door 10, the guidance module 30, and the sensor module 20, respectively.

In the present embodiment, the disaster safe smart shelter 100 is illustrated as including a total of three sectors R1, R2, and R3, but this is only one embodiment and the number of sectors R1, R2, and R3 may vary.

In addition, the disaster safe smart shelter 100 may further include a door control unit 40 that controls the opening and shutting doors 10 and a screen module 50 that displays operation data including various bus operation-related information of the bus.

Meanwhile, a transmitter for transmitting operation data may be installed in each operating bus, and a receiver for receiving the operation data transmitted from the transmitter may be installed in the disaster safe smart shelter 100.

In addition, a repeater is installed between bus stops adjacent to each other where the disaster safe smart shelter 100 is installed, and the operation data transmitted from the transmitter from a long distance may be received by the receiver as the signal is amplified via the repeater.

In this case, data transmission/reception between the transmitter, the repeater, and the receiver may be performed using various known wireless communication methods, and a wireless communication method to be developed in the future may be applied without being limited thereto.

Hereinafter, a method of operating the disaster safe smart shelter 100 will be described in detail.

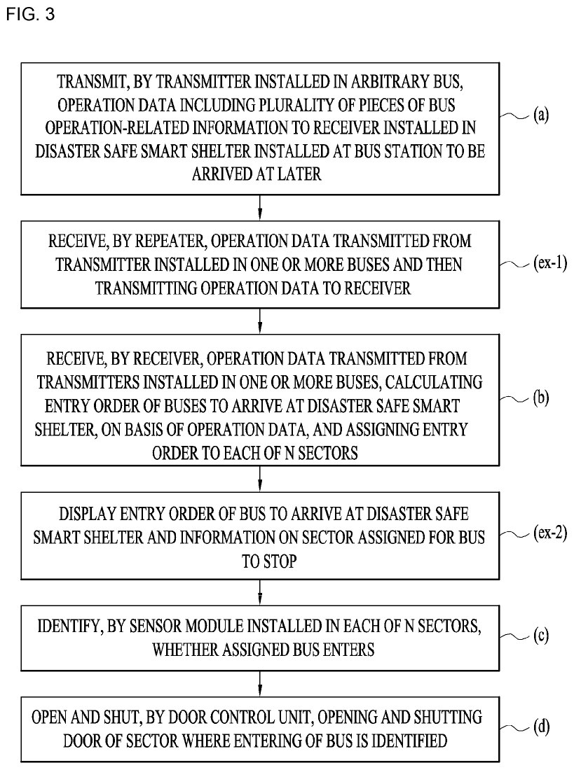

FIG. 3 is a diagram showing the entire process of the operation method of the disaster safe smart shelter 100 according to the first embodiment of the present invention.

As shown in FIG. 3, the operating method of the disaster safe smart shelter 100 according to the first embodiment of the present invention includes a step (a) for transmitting, by a transmitter installed in an arbitrary bus, operation data including a plurality of pieces of bus operation-related information to a receiver installed in the disaster safe smart shelter 100 installed at the bus station to arrive later; a step (b) for receiving, by the receiver, operation data transmitted from transmitters installed in one or more buses, calculating an entry order of buses to arrive at the disaster safe smart shelter 100, on the basis of the operation data, and assigning the entry order to each of the n sectors; a step (c) for identifying, by sensor modules 20 installed in each of the n sectors R1, R2, and R3, whether a bus assigned in the step (b) enters; and a step (d) for opening and shutting, by the door control unit 40, the opening and shutting doors 10 of the sectors R1, R2, and R3 where the entering of the bus is identified in the step (c).

In addition, a step (ex-1) for receiving, by the repeater, the operation data transmitted from the transmitter installed in one or more buses and then transmitting the operation data to the receiver may be further performed between the step (a) and the step (b), and a step (ex-2) for displaying the entry order of the buses to arrive at the disaster safe smart shelter and information on the sector assigned for the bus to stop is further performed between the step (b) and the step (c).

To this end, the disaster safe smart shelter 100 further includes the screen module 50 that displays the operation data.

That is, in the present embodiment, after calculating the arrival order from buses to arrive at a bus stop where the disaster safe smart shelter 100 is installed through the operation data received by the receiver, each bus is assigned to n sectors R1, R2, and R3 according to the arrival order.

When buses arrive at each assigned sectors R1, R2, and R3, the opening and shutting doors 10 corresponding to the respective sectors R1, R2, and R3 are opened and shut to correspond to the opening and shutting of the bus door.

In this case, the opening and shutting door 10 may includes a first opening and shutting door 10a corresponding to a front door of the bus and a second opening and shutting door 10b corresponding to a rear door of the bus, and the sensor module 20 may include an entry identification sensor 21a that determines whether the bus enters, a front door identification sensor 21b that identifies whether the front door of the bus is opened and shut, and a rear door identification sensor 21c that identifies whether the rear door of the bus is opened and shut As the sensing method of each sensor, various methods may be applied, and since this is obvious to those skilled in the art, a detailed description thereof will be omitted.

In addition, as described above, the disaster safe smart shelter 100 of the present embodiment further includes the guidance modules 30 installed in the n sectors R1, R2, and R3, respectively.

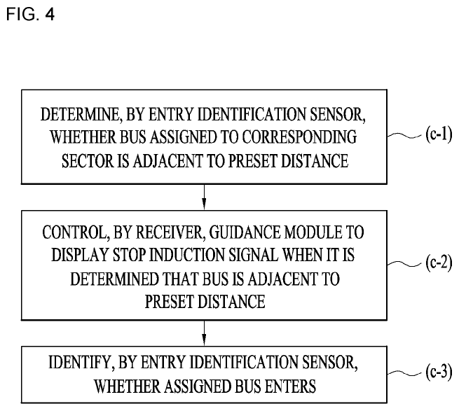

In detail, as shown in FIG. 4, the step (c) may include a step (c-1) for determining, by the entry identification sensor 21a, whether the bus assigned to the corresponding sectors R1, R2, and R3 is adjacent to a preset distance, a step (c-2) for controlling, by the receiver, the guidance module 30 to display a stop induction signal when it is determined in the step (c-1) that the bus is adjacent to a preset distance, and a step (c-3) for identifying, by the entry identification sensor 21A, whether the assigned bus enters.

That is, in the present embodiment, when a bus assigned to arbitrary sectors R1, R2, or R3 is adjacent to the corresponding sector R1, R2, or R3 within a preset distance, the guidance module 30 may display a stop induction signal to guide a bus driver to the sectors R1, R2, and R3 to be stopped.

In this case, for the stop induction signal of the guide module 30, various methods such as a method in which a predetermined light is provided in the guide module 30 to guide the sectors R1, R2, and R3 to be stopped through light, or a method in which a speaker or the like is provided to guide the sectors R1, R2, and R3 to be stopped through sound may be applied.

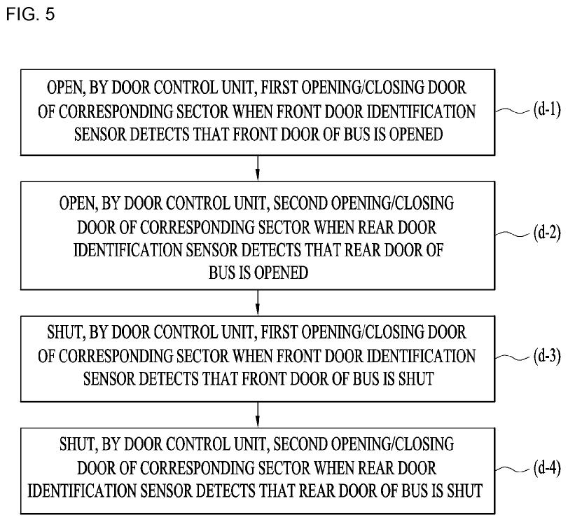

In the present embodiment, in detail, as illustrated in FIG. 5, the step (d) may include a step (d-1) for opening, by the door control unit 40, the first opening/closing door 10a of the corresponding sectors R1, R2, and R3 when the front door identification sensor detects that the front door of the bus is opened, a step (d-2) for opening, by the door control unit 40, the second opening/closing door 10b of the corresponding sectors R1, R2, and R3 when the rear door identification sensor 21c detects that the rear door of the bus is opened, a step (d-3) for shutting, by the door control unit 40, the first opening/closing door 19a of the corresponding sector when the front door identification sensor 21b detects that the front door of the bus is shut, and a step (d-4) for shutting, by the door control unit 40, the second opening/closing door 10b of the corresponding sector when the rear door identification sensor 21c detects that the rear door of the bus is shut.

That is, the front door identification sensor 21b and the rear door identification sensor 21c detect the opened and shut situations of the front and rear doors of the bus in a state in which the bus arrives at the corresponding sectors R1, R2, and R3, and transmits the detected sensing data to the door control unit 40, and the door control unit 40 opens or closes the first opening/closing door 10a or the second opening/closing door 10b by interlocking therewith.

As described above, the disaster safe smart shelter 100 of the present embodiment may provide various types of information to passengers through an operating algorithm based on Internet of Things (IoT), and provide a safe getting on and off environment by controlling the opening and shutting doors 10a and 10b of the disaster safe smart shelter 100 by interlocking with the bus entry and stop process.

Hereinafter, as another embodiment of the present invention, the part related to air conditioning control among the operating methods of the disaster safe smart shelter 100 will be described.

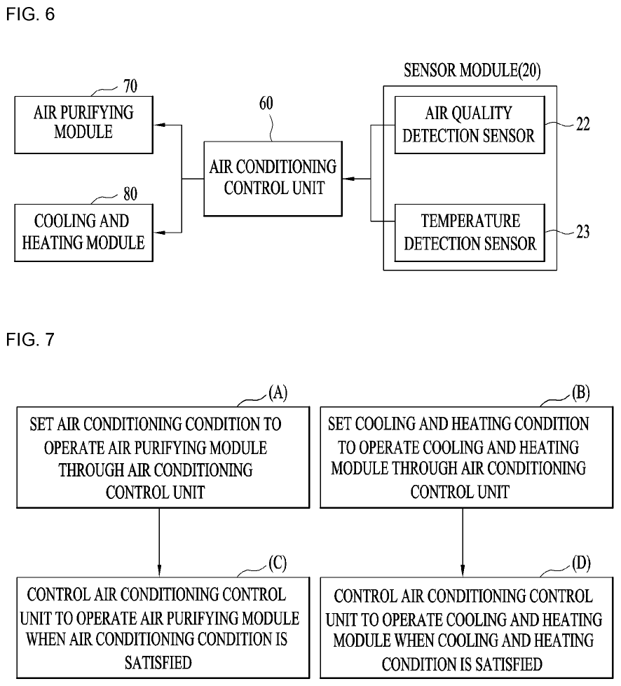

FIG. 6 is a diagram schematically illustrating a connection relationship between components interlocking with air conditioning control in the method for operating a disaster safe smart shelter 100 according to a second embodiment of the present invention.

As shown in FIG. 6, the disaster safe smart shelter 100 according to the present embodiment may include an air purifying module 70 that purifies air flowing through an air flow path connecting the waiting space S and the outside, a cooling and heating module 80 that controls the temperature of the air flowing through the air flow path, and an air conditioning control unit 60 that controls the air purifying module 70 and the cooling and heating module 80.

In addition, the disaster safe smart shelter 100 may include the sensor module including an air quality detection sensor 22 that detects a concentration of fine dust outside, an air quality detection sensor 22 that detects a concentration of fine dust in the waiting space S, and a temperature detection sensor 23 that detects the temperature of the waiting space S, and additionally, the sensor module 20 is a virus detection sensor (not shown) that detects a virus. As the virus detection sensor, a particle sensor or a sensor, such as the above-described air quality detection sensor 22, for detecting fine particles having a particle size of micro units may be applied.

Meanwhile, the air purifying module 70 may be provided with a plasma sterilizer including a plasma lamp, so harmful substances, viruses, bacteria, etc., contained in the air flowing through the air flow path may be effectively removed.

As shown in FIG. 7, the method of operating the disaster safe smart shelter according to the second embodiment of the present invention includes a step (A) for setting an air purifying condition for operating the air purifying module 70 through the air conditioning control unit 60; a step (B) for setting a cooling and heating condition for operating the cooling and heating module 80 through the air conditioning control unit 60; a step (C) for controlling, by the air conditioning control unit 60, the air purifying module 70 to operate when the air purifying condition is satisfied; and a step (D) for controlling, by the air conditioning control unit 60, the cooling and heating module 80 to operate when the cooling and heating condition is satisfied.

In this case, the air purifying condition and the cooling and heating condition may be variously set.

For example, in the step (C), when the concentration of fine dust is detected by the air quality detection sensor 22 to be greater than or equal to a preset concentration, it is determined that the air purifying condition is satisfied, and thus, the air conditioning control unit 60 may control the air purifying module 70 to operate.

Alternatively, when the preset air purifying set time arrives, it is determined that the air purifying conditions are satisfied, and thus, the air purifying control unit 60 may control the air purifying module 70 to operate. That is, the air purifying module 70 operates only at arbitrary times, thereby minimizing unnecessary operation.

In the step (D), when it is determined by the temperature detection sensor 23 that the temperature of the waiting space S is out of a preset appropriate temperature range, it is determined that the cooling and heating conditions are satisfied, and thus, the air conditioning control unit 60 may control the heating and cooling module 80 to operate.

In addition, in the step (D), as in the step (C), when the preset cooling and heating setting time arrives, it is determined that the heating and cooling conditions are satisfied, and thus, the air conditioning control unit 60 controls the heating and cooling module 80 to operate.

In this way, according to the method for operating a disaster safe smart shelter 100 of the present embodiment, a pleasant internal environment may be provided, and various complex functions may be additionally provided.

As described above, the preferred embodiments according to the present invention have been reviewed, and the fact that the present invention may be embodied in other specific forms without departing from the spirit or scope in addition to the above-described embodiments is obvious to those skilled in the art. Therefore, the embodiments described above are to be regarded as illustrative rather than restrictive, and thus the present invention is not limited to the above description, but may be modified within the scope of the appended claims and their equivalents.

1. A method for operating a disaster safe smart shelter comprising n sectors installed at a bus station, having formed therein a waiting space where a user waits, n sectors where a bus stops, an opening and shutting door installed at each of the n sectors, and a door control unit for controlling the opening and shutting door, the method for operating the disaster safe smart shelter comprising:
a step (a) for transmitting, by a transmitter installed in an arbitrary bus, operation data including a plurality of pieces of bus operation-related information to a receiver installed in the disaster safe smart shelter installed at the bus station to arrive later;
a step (ex-1) for receiving, by a repeater installed between bus stops adjacent to each other and provided to amplify a signal of operation data transmitted from the transmitter, the operation data transmitted from the transmitter installed in one or more buses and then transmitting the operation data to the receiver;
a step (b) for receiving, by the receiver, the operation data transmitted from transmitters installed in one or more buses, calculating an entry order of buses to arrive at the disaster safe smart shelter, on the basis of the operation data, and assigning the entry order to each of the n sectors;
a step (c) for identifying, by a sensor module installed in each of the n sectors, whether a bus assigned in the step (b) enters; and
a step (d) for opening and shutting, by the door control unit, the opening and shutting door of a sector where the entering of the bus is identified in the step (c),
wherein the disaster safe smart shelter further includes a guidance module that is installed in each of the n sectors and includes a predetermined light that emits light or a speaker that generates sound, and the sensor module includes an entry identification sensor that determines whether the bus enters, and
the step (c) includes:
a step (c-1) for determining, by the entry identification sensor, whether the bus assigned to the corresponding sector is adjacent to a preset distance;
a step (c-2) for controlling, by the receiver, the guidance module to display a stop induction signal when it is determined in the step (c-1) that the bus is adjacent to a preset distance to guide a bus driver to a sector where the corresponding bus stops; and
a step (c-3) for identifying, by the entry identification sensor, whether the assigned bus enters.

2. The method of claim 1, wherein the opening and shutting door includes a first opening and shutting door corresponding to a front door of the bus and a second opening and shutting door corresponding to a rear door of the bus.

3. The method of claim 2, wherein the sensor module includes the entry identification sensor that determines whether the bus enters, a front door identification sensor that identifies whether the front door of the bus is opened and shut, and a rear door identification sensor that identifies whether the rear door of the bus is opened and shut.

4. The method of claim 3, wherein the step (d) includes a step (d-1) for opening, by the door control unit, the first opening/closing door of the corresponding sector when the front door identification sensor detects that the front door of the bus is opened.

5. The method of claim 3, wherein the step (d) includes a step (d-2) for opening, by the door control unit, the second opening/closing door of the corresponding sector when the rear door identification sensor detects that the rear door of the bus is opened.

6. The method of claim 3, wherein the step (d) includes a step (d-3) for shutting, by the door control unit, the first opening/closing door of the corresponding sector when the front door identification sensor detects that the front door of the bus is shut.

7. The method of claim 3, wherein the step (d) includes a step (d-4) for shutting, by the door control unit, the second opening/closing door of the corresponding sector when the rear door identification sensor detects that the rear door of the bus is shut.

8. The method of claim 1, wherein the disaster safe smart shelter further includes a screen module that displays the operation data.

9. The method of claim 8, wherein a step (ex-2) for displaying the entry order of the buses to arrive at the disaster safe smart shelter and information on the sector assigned for the bus to stop is further performed between the step (b) and the step (c).
